(19) United States
(12) Patent Application Publication
(10) Pub. No.: US 2003/0016794 A1
(43) Pub. Date: Jan. 23, 2003

(54) COMMUNICATION OF INFORMATION VIA TWO WIRE LINES

(76) Inventor: JOHN D.W. BROTHERS, ALPHARETTA, GA (US)

Correspondence Address: FOLEY & LARDNER, 3000 K STREET N W, SUITE 500, WASHINGTON, DC, 200075109

(21) Appl. No.: 09/078,556

(22) Filed: May 14, 1998

(51) Int. Cl. H04M 11/00

(52) U.S. Cl. 379/90.01

(57) ABSTRACT

Ethernet frames of information are communicated to and from a customer premises via a two-wire telephone line which can be simultaneously used for telephone signals, using a first modem at the customer premises which operates in a first frequency band above a frequency band for the telephone signals, conveniently in a half duplex manner controlled from a head end of the line to avoid collisions of Ether net frames on the line. Ethernet frames are also coupled between terminal devices within the customer premises via the same line using further modems which operate in a second frequency band above the first frequency band, conveniently also using half duplex communications controlled by one of the further modems also to avoid collisions on the line. Ethernet frames of information are coupled for example via an Ethernet hub between the first modem and one of the further modems.

This invention relates to the communication of information via two-wire lines, such as telephone lines which can be simultaneously used for telephone communications. The invention is particularly advantageous where the information to be communicated comprises information packets such as Ethernet frames.

### BACKGROUND OF THE INVENTION

It is known to use any of various types of modem to provide for communications of information over a two-wire line, such as a telephone line which is typically in the form of a twisted pair of wires. It is also known to provide such communications at frequencies greater than those required for telephone communications, so that frequency multiplexing can be used on a telephone line for simultaneously communicating telephone signals and other information. Such other information can in particular include data that is communicated between computers and computer networks. For example, various forms of DSL (digital subscriber line) modem, generally referred to as xDSL modems, are known for this purpose and typically communicate signals using various modulation schemes and frequencies in a range from above the voice band used for telephone communications up to about 1 MHz. For communication of Ethernet frames, such modems provide the necessary conversion between the Ethernet frames and the signals communicated via the line.

An alternative approach is described in Northern Telecom Limited International Patent Application No. PCT/CA96/00601 published under number WO 97/41667 on Nov. 6, 1997 and entitled “Information Network Access Apparatus And Methods For Communicating Information Packets Via Telephone Lines”, referred to herein as the related application. In this burst mode approach, Ethernet frames are buffered and encapsulated for communication via the telephone line in half-duplex bursts on the line, the bursts being timed and controlled, by a master-slave relationship between the modems, to avoid collisions on the line. Parameters such as the communication frequency, modulation scheme, concatenation of Ethernet frames within bursts, and relative time allocations for bursts in the two opposite directions of transmission can be adaptively adjusted in relation to line characteristics, interference or crosstalk prevailing on the line, and communication requirements, in order to optimize the communications for any telephone line.

Within customer premises such as a home or office, however, there remain needs to distribute information communicated via the telephone line or other two-wire line to the premises among a plurality of terminal devices such as computers which may be located in different locations throughout the premises, and to provide communications among such devices within the customer premises. An object of this invention is to facilitate such communications via a two-wire line which can be constituted by the telephone line.

### SUMMARY OF THE INVENTION

According to one aspect, this invention provides a method of communicating information via a two-wire telephone line, comprising the steps of: communicating information to and from a customer premises via the line using a first modem coupled to the line at an end thereof distant from the customer premises and a second modem coupled to the line at the customer premises, the first and second modems operating in a first frequency band above a frequency band for telephone signals on the line; communicating information within the customer premises via the line using a plurality of further modems coupled to the line at the customer premises, the further modems operating in a second frequency band above the first frequency band; and coupling information between the second modem and one of the further modems.

Preferably the information communicated via the line comprises Ethernet information frames, the step of communicating information to and from the customer premises using the first and second modems comprises performing half duplex communications under control of the first modem, and the step of communicating information within the customer premises using the plurality of further modems comprises performing half duplex communications under control of said one of the further modems. the method can further include the step of multiplexing said one of the further modems for communications with each of a plurality of others of the further modems.

Another aspect of the invention provides apparatus comprising: a first modem coupled to a two-wire telephone line at a customer premises for communicating information via the telephone line with another modem distant from the customer premises, the first modem operating in a first frequency band above a frequency band for telephone signals on the line; a plurality of further modems coupled to the line at the customer premises, the further modems operating in a second frequency band above the first frequency band for communicating information within the customer premises; and means for coupling information between the first modem and one of the further modems.

### BRIEF DESCRIPTION OF THE DRAWINGS

The invention will be further understood from the following description with reference to the accompanying drawings, in which:

FIG. 1 schematically illustrates an arrangement in accordance with an embodiment of the invention for communicating information comprising telephone signals and data to and within a customer premises;

FIG. 2 is a graph illustrating frequency characteristics related to the arrangement of FIG. 1; and

FIG. 3 illustrates parts of a modem used in the arrangement of FIG. 1.

### DETAILED DESCRIPTION

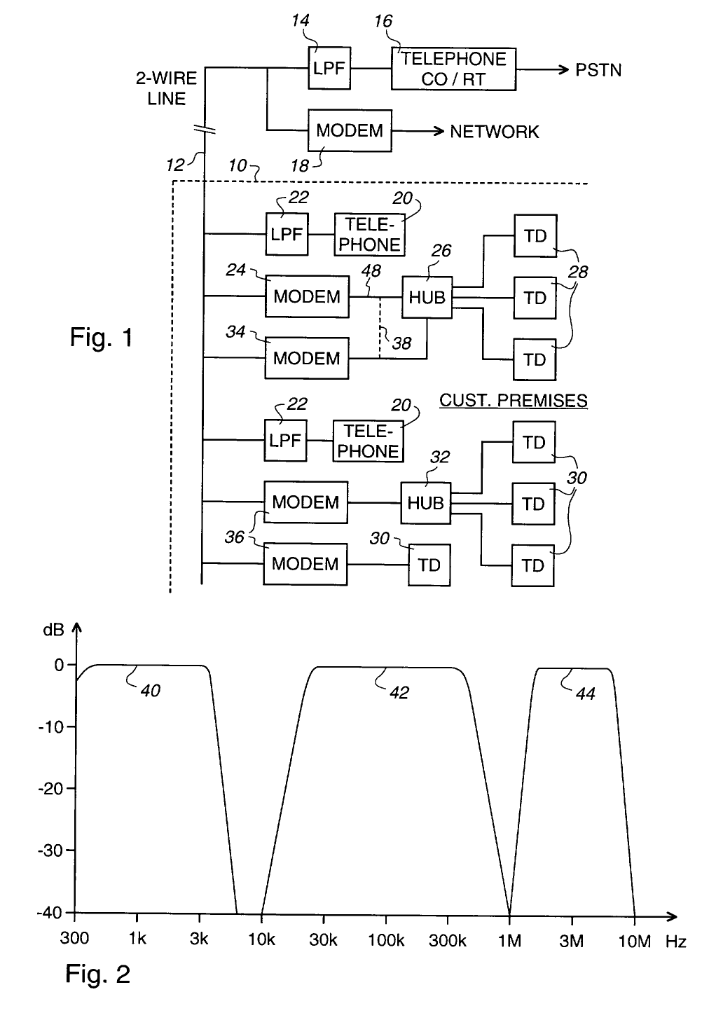

Referring to FIG. 1, there is illustrated an arrangement for communicating information to and within a customer premises, a boundary of the premises being represented by a dashed line 10, via a two-wire line which is constituted by a conventional two-wire telephone subscriber line 12. The line 12 is coupled at its head end distant from the customer premises, via a low pass filter (LPF) 14 as illustrated, to a telephone central office (CO) or remote terminal (RT) 16 and thence to a public switched telephone network (PSTN) in known manner. At the head end, the line 12 is also coupled via a modem 18 to a network on which information is communicated using Ethernet frames in known manner. For example, the network can be part of the global computer information network which is generally known as the Internet.

Within the customer premises, the line 12 is connected to one or more (two as illustrated) conventional telephones 20 in each case via a respective LPF 22. Each of the LPFs 14 and 22 has a pass band for voice and telephone signals typically in a range from about 300 Hz to about 4 kHz as shown by a line 40 in FIG. 2. The LPFs 22 can be incorporated within the telephones 22, or can be incorporated into telephone cords or receptacles that are used for connecting the telephones 20 to the line 12 within the customer premises, or can possibly be omitted. In any event, telephone communications can take place in conventional manner between the telephones 20 and the PSTN via the line 12, any LPFs 22 and 14 that may be present, and the CO/RT 16.

Also connected to the two-wire line 12 within the customer premises is a modem 24 which communicates via the line 12 with the modem 18 in a manner that is fully described in the related application referred to above, and which is briefly described below. The modems 18 and 24 operate in a master-slave relationship, with the head end modem 18 operating as a master modem and the customer premises modem 24 operating as a slave modem.

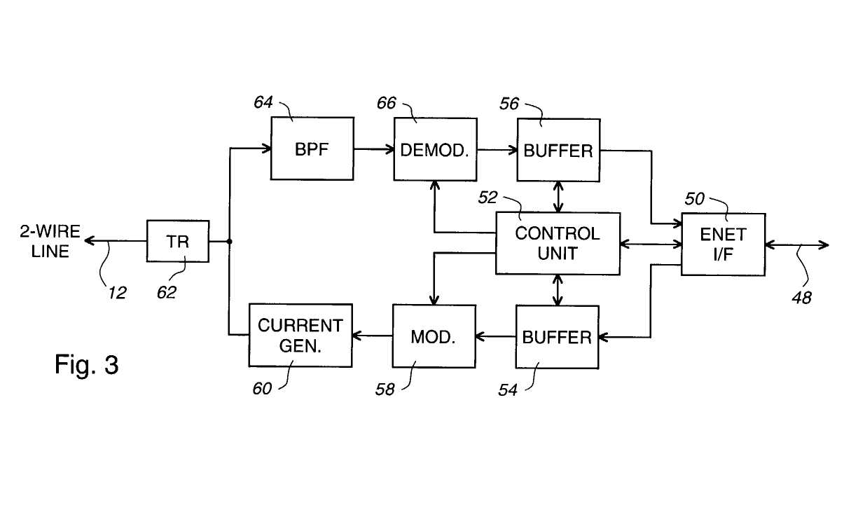

FIG. 3 illustrates a form of the modem 18; the modem 24 can have a similar form and also, as described fully in the related application, can be extended to operate in a time multiplexed manner for communications with a plurality of different slave modems 18 in one or more customer premises. However, for simplicity such multiplexing is not further described here. As also described fully in the related application, control units in the master and slave modems operate differently to provide their respective master and slave operations.

Referring to FIG. 3, the modem 18 includes an Ethernet interface 50 of known form providing for example a 10BASE-T connection to twisted pair wiring 48 and providing (for example from a read-only memory within the interface 50) an address for the modem. The interface 50 is connected to a control unit 52 of the modem, to the input of a FIFO (first in, first out) buffer 54 for buffering Ethernet frames supplied via the wiring 48 and the interface 50 for communication in an upstream direction via the line 12, and to the output of a FIFO buffer 56 for supplying Ethernet frames, received in a downstream direction via the line 12, via the interface 50 to the wiring 48. An output of the buffer 54 is coupled via a modulator 58, a current generator 60, and an isolating transformer 62 to the two-wire line 12. The transformer 62, which can also provide a balun function for the balanced line 12, is also coupled via a band pass filter (BPF) 64 and a demodulator 66 to an input of the buffer 56. The current generator 60 provides a high output impedance to avoid loading of the line 12, and the BPF 64 provides a matched termination of the line 12. Control lines are provided between the control unit 52 and the buffers 54 and 56, modulator 58, and demodulator 66.

As shown in FIG. 1, the twisted pair wiring 48 is connected to an Ethernet hub 26 to which a plurality of terminal devices (TD) 28 are also connected via respective Ethernet interfaces (not shown) in known manner. Each terminal device 28 can have any desired form for communicating Ethernet frames with the network; typically each terminal device may comprise a computer.

Communication of Ethernet frames between the TDs 28 and the network take place via the hub 26, twisted-pair wiring 48, slave modem 24, line 12, and master modem 18. Briefly, in the slave modem 24 Ethernet frames received from a TD 28 via the hub 26 and wiring 48 are buffered in the buffer 54 before being supplied to the line 12, at times dictated by the master modem 18 in order to avoid collisions of upstream and downstream information frames on the line 12, via the modulator 58, current generator 60, and transformer 62. At the master modem 18, this upstream information is demodulated in the demodulator 66 and stored in the buffer 56 of this modem, before being supplied to the network via the Ethernet interface 50 of this modem 18. In the opposite, downstream, direction, Ethernet frames received from the network via the Ethernet interface 50 of the master modem 18 are buffered in its buffer 54, then being modulated and supplied via the line 12 (again at times to avoid collisions on the line 12) to the slave modem 24, where they are demodulated and buffered in the buffer 56 before being supplied to a destination TD via the wiring 48 and the hub 26. Thus the Ethernet frames are communicated in half duplex manner on the line 12, the half duplex communications being controlled by the master modem 18. To this end, control information is also sent by the master modem 18 to the slave modem 24, and response information is also sent from the slave modem 24 to the master modem 18, again in half duplex manner, for controlling the operation of the slave modem 24 as determined by the master modem 18. For further details of such a communication arrangement, reference is directed to the related application.

In each of the modems 18 and 24 the modulator, demodulator, and related functions are conveniently implemented in known manner using one or more DSPs (digital signal processors) with analog-digital conversion in known manner. The DSPs are controlled to provide a desired signal bandwidth, consistent with characteristics of the particular line 12 such as its length and hence attenuation, interference and crosstalk, bridged taps, etc., and for example in dependence upon fills of the buffers in the modems, to provide optimum communications for the two directions of transmission on the line 12. This control can include control of the modulation scheme that is used, for example 16- or 64-QAM (quadrature amplitude modulation), QPSK (quadrature phase shift keying), or BPSK (binary phase shift keying), and the modulation symbol or clock rate. The modulation symbol rate is controlled to be within a range from about 10 kHz to about 1 MHz, corresponding to a pass band of the band pass filter 64, as shown by a line 42 in FIG. 2. Consequently, communications via the line 12 between the modems 18 and 24 occupy a different frequency range from the telephone signals also on the line 12, so that both types of communication can take place simultaneously.

The communication of Ethernet frames between the network and the wiring 48 using the modems 18 and 24 as described above is given by way of example of a preferred arrangement, and it can be appreciated that any other communications can alternatively be provided. For example, Ethernet frames could instead be communicated using an ADSL (Asymmetric DSL) communications facility, with or without the capacity for simultaneous telephone communications on the line 12. Such communications also have an upper frequency limit of the order of 1 MHz, generally corresponding to the frequency range shown by the line 42 in FIG. 2. It can be appreciated that this upper frequency limit of about 1 MHz for communications via the line 12 between the customer premises and the head end of the line 12 is relatively arbitrary, and the frequency of 1 MHz is used here only by way of a typical example.

As illustrated in FIG. 1, the customer premises also includes other terminal devices such as TDs 30, optionally with one or more further hubs such as a hub 32 to which some of the TDs 30 are connected as shown in FIG. 1, which are desired to be able to communicate with one another and with the TDs 28 via a local area network (LAN) within the customer premises, and optionally also to be able to communicate with the head end network. The two-wire line 12 within the customer premises is also used to facilitate the provision of this LAN, as described below.

To this end, the customer premises also includes a master modem 34, which can be similar to the master modem 18 except as described below, and one or more further slave modems 36, each of which can be similar to the slave modem 24 except as described below, which are also connected to the line 12 within the customer premises. The Ethernet interface of the master modem 34 is connected to the hub 26, and the Ethernet interfaces of the slave modems 36 are connected to other hubs such as the hub 32 or directly to respective ones of the TDs 30. It can be appreciated that each of the devices, and more specifically the Ethernet interfaces thereof, can have a respective address to enable the specific device to be addressed and identified in known manner.

The modems 34 and 36 differ from the modems 18 and 24 particularly in that they are arranged to communicate with one another within a higher frequency range than the modems 18 and 24, for example within a frequency range from about 1 to 10 MHz as shown by a line 44 in FIG. 2. The band pass filters and symbol rates of the modems 34 and 36 are determined accordingly. The modems 34 and 36 can optionally be simplified in relation to the modems 18 and 24, for example they may provide more restricted choices of modulation scheme and symbol rates, or these may be predetermined. In other words, for the higher frequency modems 34 and 36 the adaptive adjustment of symbol rate, modulation scheme, etc. as discussed above can be optionally provided.

With two slave modems 36 provided as shown in FIG. 1, it can be appreciated that the master modem 34 is multiplexed for communications with each of these. Multiplexing of a master modem is fully described in the related application, but for the modem 34 can be considerably simplified in relation thereto because all of the slave modems are connected to the same line 12, and because the modems themselves may be simplified as indicated above. For example, operation of the master modem 34 can be divided among a predetermined number of, e.g. 32, time slots, which can be allocated individually or collectively to respective slave modems 36 to provide the higher frequency communications between the modems at desired rates.

Because the communications among the modems 34 and 36 are within the higher frequency range as shown by the line 44 in FIG. 2, they do not interfere with or detract from the Ethernet and telephone communications also on the line 12 within their respective frequency ranges. Within the customer premises, the two-wire line 12 has a relatively limited length, which enables signals in this higher frequency range to be communicated without excessive attenuation. These high frequency signals also propagate upstream on the line 12 towards the head end thereof, but are greatly attenuated over the length of this line so that they are of no effect at the head end. These higher frequency signals are also filtered out by the LPFs 22 and by the BPF 64 in the modem 24. Conversely, the BPFs in the high frequency modems 34 and 36 filter out the lower frequency Ethernet signals on the line 12.

Ethernet LAN communications between a TD 30 and a TD 28 are effected via any intervening hub 32, the respective slave modem 36, the line 12 within the customer premises, the master modem 34, and the hub 26 using the high frequency communications range of the modems 34 and 36 and half duplex communications on the line 12 controlled by the master modem 34. Communications from a TD 30 to the network at the head end of the line 12 are similarly conducted to the hub 26, from where they are routed (in accordance with the Ethernet addressing) to the slave modem 24 and then, using the lower frequency Ethernet communications via the line 12 to the head end, via the line 12 and the master modem 18 to the network. In the reverse direction, Ethernet frames from the network are routed via the master modem 18, line 12, and slave modem 24 at the lower frequencies and thence to the hub 26, from where they are routed to the respective TD 30 via the master modem 34, line 12, and respective slave modem 36 operating at the higher frequency range.

It can be appreciated that the slave modem 26 does not need to be connected via a hub 26 to TDs 28 as shown in FIG. 1. Instead, as shown by a dashed line 38 in FIG. 1, the Ethernet interface 50 of the lower frequency slave modem 24 could be connected directly to an Ethernet interface of the higher frequency master modem 34 for the communication of all Ethernet frames thereto, and thence via the line 12 within the higher frequency range to respective TDs 30 via respective slave modems 36. In this case it can be seen that the modems 24 and 34 can be combined into a single unit with a number of the individual functions thereof merged. It can also be appreciated that, in a similar manner, one or more of the higher frequency slave modems 36 can be arranged also to operate as a lower frequency slave modem for communications directly with and controlled by the master modem 18. It can further be appreciated that, although as described above the modem 34 is the master modem for the higher frequency communications on the line 12 within the customer premises, any of the other higher frequency communication modems 36, or a separate master modem provided for controlling the higher frequency communications, could instead be used as the master modem for such communications.

As described above, the LPFs 14 and 22 and BPFs 64 are provided for filtering signals at the respective frequencies for their respective devices (telephones or modems). This arrangement facilitates the use of the single two-wire telephone line 12 for all of the communications within the customer premises as illustrated in FIG. 1. However, it can be appreciated that other filtering arrangements can alternatively be provided, and some or all of the filters may not necessarily be required. For example, the band pass filters 64 could be replaced by high pass filters, and/or could be combined with the LPFs 22 in the manner of frequency diplexers as described in the related application.

Although as described above Ethernet hubs 26 and 32 are provided, it can be appreciated that these can be replaced by any other apparatus for coupling, distributing, or routing Ethernet frames, such as a router or brouter.

Although a particular embodiment of the invention and various modifications have been described in detail, it should be appreciated that numerous other modifications, variations, and adaptations may be made without departing from the scope of the invention as defined in the claims.

What is claimed is:

1. A method of communicating information via a two-wire telephone line, comprising the steps of:
communicating information to and from a customer premises via the line using a first modem coupled to the line at an end thereof distant from the customer premises and a second modem coupled to the line at the customer premises, the first and second modems operating in a first frequency band above a frequency band for telephone signals on the line;
communicating information within the customer premises via the line using a plurality of further modems coupled to the line at the customer premises, the further modems operating in a second frequency band above the first frequency band; and
coupling information between the second modem and one of the further modems.

2. A method as claimed in claim 1 wherein the information communicated via the line comprises Ethernet information frames.

3. A method as claimed in claim 2 wherein information is coupled between the second modem and said one of the further modems via an Ethernet hub.

4. A method as claimed in claim 1 wherein the step of communicating information to and from the customer premises using the first and second modems comprises performing half duplex communications under control of the first modem.

5. A method as claimed in claim 4 wherein the step of communicating information within the customer premises using the plurality of further modems comprises performing half duplex communications under control of said one of the further modems.

6. A method as claimed in claim 5 and further including the step of multiplexing said one of the further modems for communications with each of a plurality of others of the further modems.

7. A method as claimed in claim 1 wherein the step of communicating information within the customer premises using the plurality of further modems comprises performing half duplex communications under control of one of the further modems.

8. A method as claimed in claim 1 wherein the first frequency band is below, and the second frequency band is above, a frequency of the order of 1 MHz.

9. A method as claimed in claim 1 and including the step of simultaneously communicating telephone signals via the line.

10. Apparatus comprising:
a first modem coupled to a two-wire telephone line at a customer premises for communicating information via the telephone line with another modem distant from the customer premises, the first modem operating in a first frequency band above a frequency band for telephone signals on the line;
a plurality of further modems coupled to the line at the customer premises, the further modems operating in a second frequency band above the first frequency band for communicating information within the customer premises; and
means for coupling information between the first modem and one of the further modems.

11. Apparatus as claimed in claim 10 and further comprising at least one telephone coupled to the line at the customer premises for simultaneous communication of telephone signals via the line.

12. Apparatus as claimed in claim 11 wherein the telephone is coupled to the line via a low pass filter.

13. Apparatus as claimed in claim 10 wherein the first modem comprises a modem for half duplex communications controlled by said another modem distant from the customer premises to avoid collisions of information communicated in the first frequency band on the line.

14. Apparatus as claimed in claim 13 wherein the plurality of further modems comprise modems for half duplex communications, controlled by one of the further modems, to avoid collisions of information communicated in the second frequency band on the line within the customer premises.

15. Apparatus as claimed in claim 14 wherein at least some of the first and plurality of further modems each include an Ethernet interface.
